(19) United States
(12) Patent Application Publication
(10) Pub. No.: US 2011/0001938 A1
(43) Pub. Date: Jan. 6, 2011

(54) Optical projection system

(76) Inventor: Wen-Pang Tsai, Hsin-Chu (TW)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/801,626

(22) Filed: Jun. 17, 2010

(30) Foreign Application Priority Data
Jul. 1, 2009 (TW) 098122238

(51) Int. Cl. G03B 21/14

(52) U.S. Cl. 353/84; 353/119

(57) ABSTRACT

An optical projection system includes a bottom cover, a foundation flat plate, at least one supporting element, a light source module, and an optical engine module. The bottom cover includes a bottom plate and two opposite side plates. The side plates are respectively connected with two ends of the bottom plate. The side plates and the bottom plate form an accommodating space. The foundation flat plate located between the side plates is disposed on the bottom plate. The foundation flat plate is apart from the side plates. The supporting element is disposed on the foundation flat plate. The light source module is disposed on the foundation flat plate. The optical engine module is disposed on the supporting element. The foundation flat plate, the supporting element, at least part of optical engine module, and at least part of the light source module are disposed in the accommodating space.

### CROSS-REFERENCE TO RELATED APPLICATION

This application claims the priority benefit of Taiwan application serial no. 98122238, filed on Jul. 1, 2009. The entirety of the above-mentioned patent application is hereby incorporated by reference herein and made a part of this specification.

### BACKGROUND OF THE INVENTION

1. Field of the Invention

The invention relates to an optical electronic system, and more particularly relates to an optical projection system.

2. Description of Related Art

A fixing manner of a relative position between a light source module and an optical engine module of an optical projection system is closely related to image quality projected by the optical projection system. The fixing manner of the relative position between the light source module and the optical engine module has been disclosed in many patents, such as FIG. 2 of Taiwan patent No. I231403, FIG. 2C of Taiwan patent No. I258053, and FIGS. 4 and 5 of U.S. Pat. No. 7,296,900. Two other kinds of fixing manners used in present industry may be specified in the followings.

FIG. 1 is an exploded three dimensional view of a conventional optical projection system. Referring to FIG. 1, the related optical projection system 100 includes a shielding cover 110, a supporting bottom cover 120, a plurality of supporting elements 130, a light source module 140, and an optical engine module 150. The supporting elements 130 are disposed on the shielding cover 110, and the optical engine module 150 is disposed on the supporting elements 130. The shielding cover 110 is disposed on the supporting bottom cover 120, and the material of the shielding cover 110 is metal to prevent electromagnetic interference (EMI) from outside. In addition, the light source module 140 is disposed on the supporting bottom cover 120 and through the shielding cover 110.

The light source module 140 is disposed on the supporting bottom cover 120, and the optical engine module 150 is disposed on the shielding cover 110 through the supporting elements 130. When the shielding cover 110 and the supporting bottom cover 120 are assembled, the cumulative tolerance between the optical engine module 150 and the light source module 140 may be increased. To solve the problem, another related optical projection system is provided.

FIG. 2 is an exploded three dimensional view of another conventional optical projection system. Referring to FIG. 2, the related optical projection system 200 includes a shielding cover 210, a supporting bottom cover 220, a plurality of supporting elements 230, a light source module 240, and an optical engine module 250. The supporting elements 230 are disposed on a bottom plate 222 of the supporting bottom cover 220, the light source module 240 is disposed on the bottom plate 222, and the light source module 240 is disposed besides the supporting elements 230. The shielding cover 210 is disposed on the supporting bottom cover 220, and the supporting elements 230 and the light source module 240 are through the shielding cover 210. The optical engine module 250 is disposed on the supporting elements 230. In addition, the material of the shielding cover 210 is metal, and the material of the supporting bottom cover 220 is plastic.

However, since the difference between the material of the shielding cover 210 and the material of the supporting bottom cover 220 and the tolerance existing in the shielding cover 210 and the supporting bottom cover 220 to cause the supporting bottom cover 220 to deform, the flatness of the bottom plate 222 of the supporting bottom cover 220 may be not good, and the stability of the position of the light source module 240 relative to the optical engine module 250 is not good. Therefore, the light beam emitted by the light source module 240 may not be effectively and steadily used by the optical engine module 250.

### SUMMARY OF THE INVENTION

The invention provides a optical projection system, and the stability of the position of the light source module relative to the optical engine module is good.

Other objectives and advantages of the invention may be further indicated by the disclosures of the invention.

To achieve at least one of the above-mentioned objectives, or to achieve other objectives, an embodiment of the invention provides an optical projection system, including: a bottom cover, a foundation flat plate, at least one supporting element, a light source module, and an optical engine module. The bottom cover includes a bottom plate and two opposite side plates. The side plates are respectively connected with two ends of the bottom plate, and the side plates and the bottom plate form an accommodating space. The foundation flat plate is disposed on the bottom plate and located between the side plates. The foundation flat plate is apart from the side plates.

The supporting element is disposed on the foundation flat plate. The light source module is disposed on the foundation flat plate and capable of emitting an illuminating beam. The optical engine module is disposed on the supporting elements and located in a transmission path of the illuminating beam. The foundation flat plate, the supporting elements, at least part of the optical engine module, and at least part of the light source module are disposed in the accommodating space.

In one embodiment of the invention, the foundation flat plate is made of plastic or metal.

In one embodiment of the invention, the bottom cover is made of plastic.

In one embodiment of the invention, the above-mentioned optical engine module includes a color wheel, a light valve, and a projection lens. The color wheel is located in the transmission path of the illuminating beam and capable of filtering the illuminating beam to make a filtered illuminating beam pass through the color wheel. The light valve is located in a transmission path of the filtered illuminating beam and capable of converting the filtered illuminating beam into an image beam. The projection lens is located in a transmission path of the image beam and capable of projecting the image beam.

In one embodiment of the invention, the above-mentioned optical projection lens further includes a power and control module disposed on the bottom plate and at least partially located in the accommodating space. The power and control module includes a circuit beard and a power. The optical engine module and the light source module are electrically connected with the circuit board. The power is electrically connected with the circuit board. In addition, the power and control module further includes a ring-shaped casing, and the ring-shaped casing is disposed on the bottom plate and located in the accommodating space. The power and the circuit board are disposed in a range surrounded by the ring-shaped casing, and the ring-shaped casing has two opposite electromagnetic interference shielding walls.

In one embodiment of the invention, the above-mentioned bottom plate has a supporting plane. The supporting plane has a ring-shaped edge. The side plates are located on the ring-shaped edge. The foundation flat plate is disposed on the supporting plane and located in a range surrounded by the ring-shaped edge.

According to the embodiment of the invention, because the light source module of the optical projection system is disposed on the foundation flat plate, and the optical engine module is disposed on the foundation flat plate through the supporting elements, comparing with the conventional technique, the cumulative tolerance between the optical engine module and the light source module of the optical projection system according to the embodiment of the invention may be decreased.

In addition, the foundation flat plate of the optical projection system according to the embodiment of the invention is disposed on the bottom plate of the bottom cover and located between the side plates, and the foundation flat plate is apart from the side plates. Therefore, comparing with the conventional technique, after the foundation flat plate of the optical projection system of the embodiment of the invention is assembled with the bottom cover of the optical projection system of the embodiment of the invention, the foundation flat plate and the bottom cover of the optical projection system according to the embodiment of the invention may not generate interference. Accordingly, the flatness of the foundation flat plate disposed on the bottom plate may be better, and the stability of the position of the light source module relative to the optical engine module may be improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded three dimensional view of a conventional optical projection system.

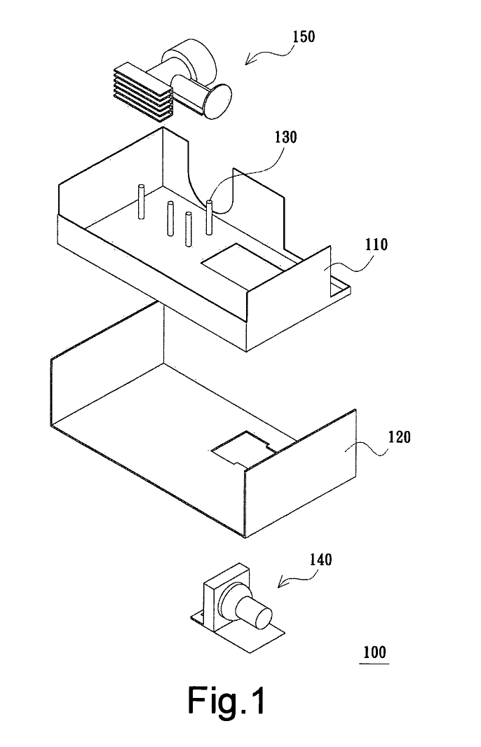

FIG. 2 is an exploded three dimensional view of another conventional optical projection system.

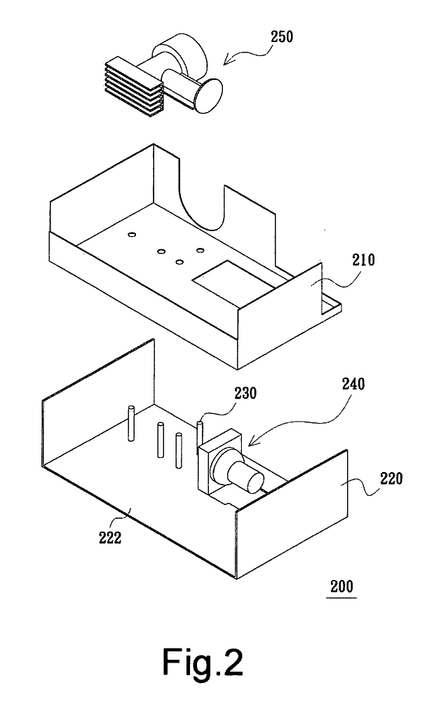

FIG. 3 is a three dimensional view of an optical projection system according to one embodiment of the invention.

FIG. 4 is an exploded view of the optical projection system in FIG. 3.

FIG. 5 is a top view of the optical projection system in FIG. 3.

FIG. 6 is a side view of the assembly of part of the components of the optical projection system in FIG. 3.

FIG. 7 is a three dimensional view of the assembly of part of the components of the optical projection system in FIG. 3.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

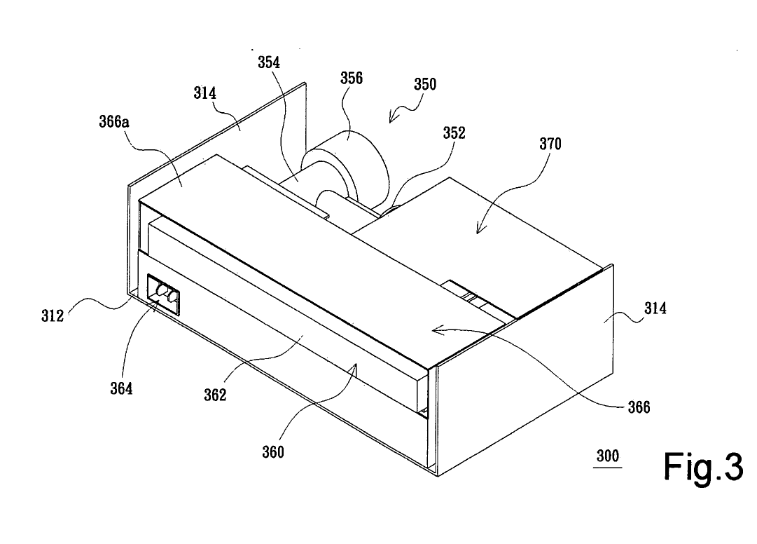

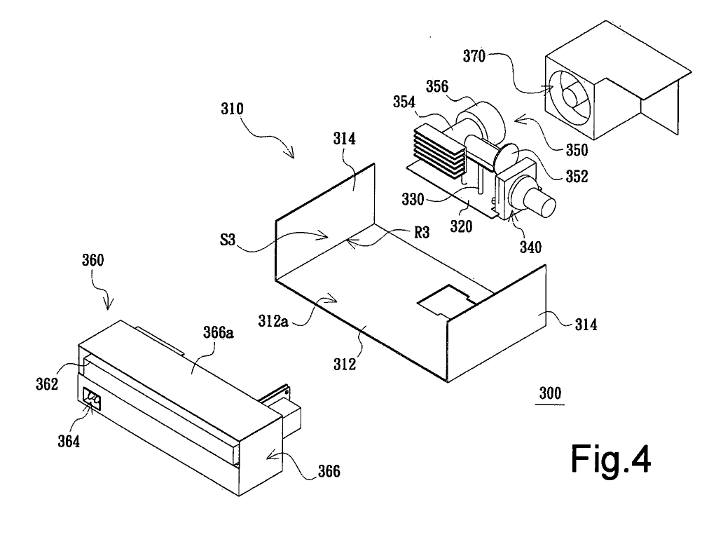

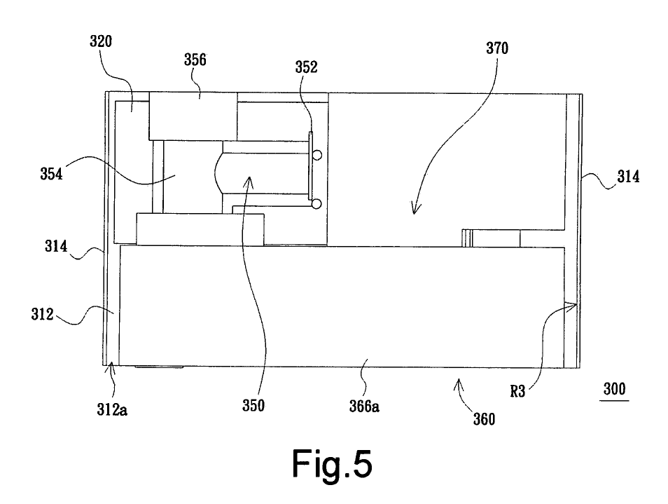

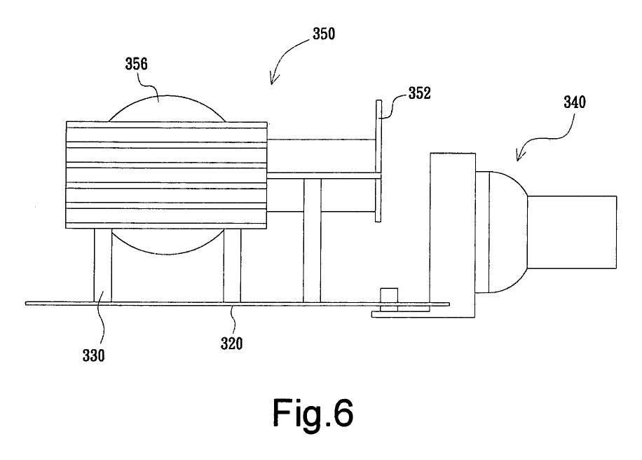

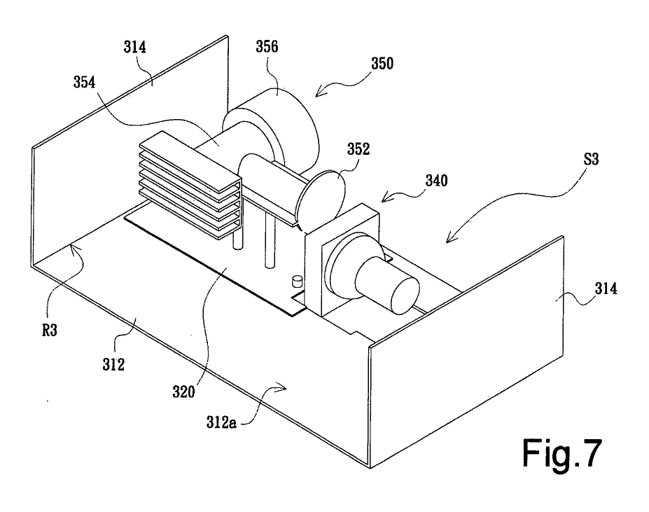

Referring to FIGS. 3 to 7, the optical projection system 300 of the embodiment includes a bottom cover 310, a foundation flat plate 320, at least one supporting element 330, a light source module 340, an optical engine module 350, a power and control module 360, and a fan 370. The bottom cover 310 includes a bottom plate 312 and two opposite side plates 314. The side plates 314 are respectively connected with two ends of the bottom plate 312, and the side plates 314 and the bottom plate 312 form an accommodating space S3. The material of the bottom cover 310 is, for example, plastic.

The material of the foundation flat plate 320 is, for example, plastic or metal. The foundation flat plate 320 is disposed on the bottom plate 312 and located between the side plates 314. The foundation flat plate 320 is apart from the side plates 314. Specifically, the bottom plate 312 has a supporting plane 312a. The supporting plane 312a has a ring-shaped edge R3. The side plates 314 are disposed on the ring-shaped edge R3. The foundation flat plate 320 is disposed on the supporting plane 312a and located in a range surrounded by the ring-shaped edge R3. In addition, the supporting elements 330 are disposed on the foundation flat plate 320. The material of the supporting elements 330 is the same as the material of the foundation flat plate 320, and the supporting elements 330 are formed integrally with the foundation flat plate 320.

The light source module 340 is disposed on the foundation flat plate 320 and capable of emitting an illuminating beam. The optical engine module 350 is disposed on the supporting elements 330 and located in a transmission path of the illuminating beam. The foundation flat plate 320, the supporting elements 330, at least part of the optical engine module 350, and at least part of the light source module 340 are disposed in the accommodating space S3. In the embodiment, the optical engine module 350 includes a color wheel 352, a light valve 354, and a projection lens 356. The color wheel 352 is located in the transmission path of the illuminating beam and capable of filtering the illuminating beam to make the filtered illuminating beam pass through the color wheel 352. The light valve 354 is located in a transmission path of the filtered illuminating beam and capable of converting the filtered illuminating beam into an image beam. The projection lens 356 is located in a transmission path of the image beam and capable of projecting the image beam onto an external screen (not shown).

Because the light source module 340 is disposed on the foundation flat plate 320, and the optical engine module 350 is disposed on the foundation flat plate 320 through the supporting elements 330, comparing with the conventional optical projection system 100, the cumulative tolerance between the optical engine module 350 and the light source module 340 may be decreased.

In addition, the foundation flat plate 320 is disposed on the bottom plate 312 of the bottom cover 310 and located between the side plates 314, and the foundation flat plate 320 is apart from the side plates 314, so comparing with the conventional optical projection system 200, after the foundation flat plate 320 is assembled with the bottom cover 310, the foundation flat plate 320 and the bottom cover 310 may not generate interference. Therefore, the flatness of the foundation flat plate 320 disposed on the bottom plate 312 is better, and the stability of the position of the light source module 340 relative to the optical engine module 350 may be improved.

The power and control module 360 is disposed on the bottom plate 312 and at least partially located in the accommodating space S3. The power and control module 360 includes a circuit beard 362, a power 364, and a ring-shaped casing 366. The ring-shaped casing 366 is disposed on the bottom plate 312 and located in the accommodating space S3. The power 364 and the circuit board 362 are disposed in a range surrounded by the ring-shaped casing 366, and the ring-shaped casing 366 has two opposite electromagnetic interference shielding walls 366a. In the embodiment, each of the electromagnetic interference shielding walls 366a is substantially perpendicular to each of the side plates 314 of the bottom cover 310. In addition, the optical engine module 350, the light source module 340, and the power 364 are electronically connected to the circuit board 362.

The fan 370 is disposed on the bottom plate 312 and at least partially located in the accommodating space S3. The fan 370 is adjacent to the light source module 340 and capable of generating an airflow for cooling the light source module 340 in operation.

In summary, the embodiment or embodiments of the invention may have at least one of the following advantages:

Because the light source module of the optical projection system according to the embodiments of the invention is disposed on the foundation flat plate, and the optical engine module is disposed on the foundation flat plate through the supporting elements, comparing with the conventional technique, the cumulative tolerance between the optical engine module and the light source module of the optical projection system according to the embodiment of the invention may be decreased.

The foundation flat plate of the optical projection system according to the embodiment of the invention is disposed on the bottom plate of the bottom cover and located between the side plates, and the foundation flat plate is apart from the side plates. Therefore, comparing with the conventional technique, after the foundation flat plate of the optical projection system according to the embodiment of the invention is assembled with the bottom cover of the optical projection system according to the embodiment of the invention, the foundation flat plate and the bottom cover of the optical projection system according to the embodiment of the invention may not generate interference. Accordingly, the flatness of the foundation flat plate disposed on the bottom plate may be better, and the stability of the position of the light source module relative to the optical engine module may be improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical projection system, comprising:
a bottom cover, comprising a bottom plate and two opposite side plates, wherein the side plates are respectively connected with two ends of the bottom plate, and the side plates and the bottom plate form an accommodating space;
a foundation flat plate, disposed on the bottom plate and located between the side plates, wherein the foundation flat plate is apart from the side plates;
at least one supporting element, disposed on the foundation flat plate;
a light source module, disposed on the foundation flat plate and capable of emitting an illuminating beam; and
an optical engine module, disposed on the supporting element and located in a transmission path of the illuminating beam, wherein the foundation flat plate, the supporting element, at least part of the optical engine module, and at least part of the light source module are disposed in the accommodating space.

2. The optical projection system according to claim 1, wherein the foundation flat plate is made of plastic or metal.

3. The optical projection system according to claim 1, wherein the bottom cover is made of plastic.

4. The optical projection system according to claim 1, wherein the optical engine module comprises:
a color wheel, located in the transmission path of the illuminating beam and capable of filtering the illuminating beam to make a filtered illuminating beam pass through the color wheel;
a light valve, located in a transmission path of the filtered illuminating beam and capable of converting the filtered illuminating beam into an image beam; and
a projection lens, located in a transmission path of the image beam and capable of projecting the image beam.

5. The optical projection system according to claim 1, further comprising a power and control module disposed on the bottom plate and at least partially located in the accommodating space, the power and control module comprising:
a circuit board, wherein the optical engine module and the light source module are electrically connected with the circuit board; and
a power, electrically connected with the circuit board.

6. The optical projection system according to claim 5, wherein the power and control module further comprises a ring-shaped casing disposed on the bottom plate and located in the accommodating space, the power and the circuit board are disposed in a range surrounded by the ring-shaped casing, and the ring-shaped casing has two opposite electromagnetic interference shielding walls.

7. The optical projection system according to claim 1, wherein the bottom plate has a supporting plane having a ring-shaped edge, the side plates are located on the ring-shaped edge, and the foundation flat plate is disposed on the supporting plane and located in a range surrounded by the ring-shaped edge.
